(19) United States
(12) Patent Application Publication
(10) Pub. No.: US 2017/0186047 A1
(43) Pub. Date: Jun. 29, 2017

(54) OPTIMIZATION OF AUDIENCE GROUPS IN ONLINE ADVERTISING BIDDING

(71) Applicant: INTERNATIONAL BUSINESS MACHINES CORPORATION, ARMONK, NY (US)

(72) Inventors: YING LI, YORKTOWN HEIGHTS, NY (US); PIETRO MAZZOLENI, YORKTOWN HEIGHTS, NY (US); PAVANKUMAR MURALI, YORKTOWN HEIGHTS, NY (US); ROMAN VACULIN, YORKTOWN HEIGHTS, NY (US)

(21) Appl. No.: 14/980,119

(22) Filed: Dec. 28, 2015

(51) Int. Cl. G06Q 30/02

(52) U.S. Cl. CPC G06Q 30/0275

(57) ABSTRACT

A method for automatic placement opportunity bidding of digital advertising in a real-time advertisement exchange includes receiving a request for an ad placement opportunity from the exchange or a content publisher. The request includes information pertaining to a user who is presently viewing on-line content. Audience segments that the user belongs to are identified. An audience group is identified based on the audience segments. It is determined if a first and/or a second ad campaign of an advertiser should respond to the requests based on the identified audience group. When there is an audience conflict, it is resolved to identify one single ad campaign to respond to the placement opportunity request. The bid for the placement opportunity is submitted on behalf of the identified ad campaign.

### BACKGROUND

1. Technical Field

The present disclosure relates to online advertising and, more specifically, to systems and methods for optimizing audience groups in exchanges for online advertising bidding.

2. Discussion of Related Art

As the Internet becomes increasingly important form of media, the Internet, and in particular, websites, connected mobile applications, on-line video games, and the like, are fast becoming an important platform for advertisements. For example, display ads, which are advertisements presented in or over a browser-rendered website, may be used as a way of monetizing internet-connected media.

Traditionally, it would be necessary for an advertiser to contract directly with an internet media outlet for the display of advertisements therein. However, more recently, various demand-side platforms (DSP) have been implemented to facilitate marketplaces where advertisers and Internet media outlets can contract for display advertising. The Internet media outlets may themselves sell digital advertising such as display ads, or digital advertising inventory may be sold from other parties such as intermediaries.

Some DSPs may utilize real-time bidding (RTB) in which a seller of digital advertising inventory, for example, a website operator, sells the right to display an advertisement to a particular user who is accessing the website at that very moment. The seller of digital advertising inventory may identify some details concerning the present user and various advertisers may algorithmically issue bids to display their ad to that particular user.

Often the identified details for the user include disclosing, to the advertisers, an audience group (AG) of that particular user. Alternatively, the advertisers may determine for themselves an AG of the user based on the identified details. In either event, the determined AG of the user may be used by the advertiser's algorithmic bidding engine to determine the value for the particular bid. The bidding engine may use knowledge of a particular ad campaign to calculate a value associated with directing that ad campaign to the determined AG of a given user. For example, an ad campaign related to a chimney cleaning product may be better directed to an AG representing homeowners than an AG representing apartment renters.

However, a problem may arise in instances where a given advertiser has multiple simultaneous ad campaigns. In such a case it may be possible for the bidding engine of a single advertiser to issue bids for its multiple ad campaigns, thereby bidding against itself for users in the same AG. This situation may be referred to herein as an audience conflict, as both ad campaigns may be vying for a common AG.

### BRIEF SUMMARY

A method for automatic placement opportunity bidding of digital advertising in a real-time advertisement exchange includes receiving one or more requests for an ad placement opportunity from the real-time advertisement exchange or directly from a content publisher. The one or more requests include information pertaining to a user who is presently viewing on-line content. One or more audience segments that the user belongs to are identified based on the received information pertaining to the user. An audience group that the user belongs to is identified based on the identified one or more audience segments. It is determined if a first ad campaign of an advertiser should respond to the one or more requests based on the identified audience group of the user. It is also determined if a second ad campaign of the advertiser should respond to the one or more requests based on the identified audience group of the user. An audience conflict is resolved to identify one single ad campaign, of the first and second ad campaigns, that should submit a bid for the placement opportunity when it is determined that both the first ad campaign and the second as campaign should respond to the one or more requests. The bid for the placement opportunity is submitted to the real-time advertisement exchange on behalf of the identified one single ad campaign, of the first and second ad campaigns that should submit the bid.

The audience group that the user belongs to may be identified based on the identified one or more audience segments using a pre-arranged table defining audience groups by pluralities of audience segments. The pre-arranged table defining audience groups may be optimized by maximizing one or more key performance indicators (KPI) while respecting budget constraint for each audience group. The one or more KPIs may include estimations of total conversions/conversion rates or total clicks/click-through rates associated with the audience groups.

One or more factors may be considered to resolve an audience conflict resulting from the determination that both the first ad campaign and the second ad campaign should submit a bid for the placement opportunity request. The one or more factors may include maximizing one or more key performance indicators (KPI) while respecting budget constraints for the first and second ad campaigns. The one or more KPIs may include estimations of total conversions/conversion rates or total clicks/click-through rates associated with the definitions of the audience groups.

The one or more factors may include a set of pre-defined business rules designed to resolve audience conflicts. Resolving the audience conflict may include determining a first probability of showing the ad from the first ad campaign and a second probability of showing the ad from the second ad campaign. The first and second probabilities may respectively control the frequency of determining the campaign should respond to the one or more requests in favor of the first and second ad campaign, wherein the first and second probabilities sum up to 1.

A method for automatic placement opportunity bidding for digital advertising in a real-time advertisement exchange includes defining a first audience group as a target audience for a first ad campaign, the first audience group including a first plurality of audience segments. A second audience group is defined as a target audience for a second ad campaign, the second audience group including a second plurality of audience segments. The definition of audience groups is optimized across both the first and second ad campaigns. A placement opportunity request is received from the real-time advertisement exchange, or directly from a content publisher. The placement opportunity request includes information pertaining to a user who is presently viewing on-line content. It is determined if the first ad campaign should respond to the placement opportunity request based on the definition of the first audience group and the information pertaining to the user who is presently viewing on-line content. It is determined if the second ad campaign should respond to the placement opportunity request based on the definition of the second audience group and the information pertaining to the user who is presently viewing on-line content. Either the first ad campaign or the second ad campaign is selected to submit a bid for the placement opportunity by resolving potential audience conflict based on a maximization of one or more key performance indicators (KPI) while respecting budget constraints for each of the first and second ad campaigns. A bid for the placement opportunity is submitted to the real-time advertisement exchange on behalf of the selected ad campaign.

The one or more KPIs may include estimations of total conversions/conversion rates or total clicks/click-through rates associated with the audience groups.

Selecting either the first ad campaign or the second ad campaign to submit a bid for the digital advertising space may further include implementing a set of pre-defined business rules designed to resolve audience conflicts.

Resolving the audience conflict may include determining a first probability of showing the ad from the first ad campaign and a second probability of showing the ad from the second ad campaign.

A computer system includes a processor and a non-transitory, tangible, program storage medium, readable by the computer system, embodying a program of instructions executable by the processor to perform method steps for automatic placement opportunity bidding for digital advertising in a real-time advertisement exchange. The method includes defining a first audience group as a target audience for a first ad campaign. The first audience group includes a first plurality of audience segments. A second audience group is defined as a target audience for a second ad campaign. The second audience group includes a second plurality of audience segments. The definition of audience groups is optimized across both the first and second ad campaigns. A placement opportunity request is received from the real-time advertisement exchange, or directly from a content publisher. The placement opportunity request includes information pertaining to a user who is presently viewing on-line content. It is determined if the first ad campaign should respond to the placement opportunity request based on the definition of the first audience group and the information pertaining to the user who is presently viewing on-line content. It is also determined if the second ad campaign should respond to the placement opportunity request based on the definition of the second audience group and the information pertaining to the user who is presently viewing on-line content. Either the first ad campaign or the second ad campaign is selected to submit a bid for the placement opportunity by resolving potential audience conflict based on a maximization of one or more key performance indicators (KPI) while respecting budget constraints for each of the first and second ad campaigns. A bid for the placement opportunity is submitted to the real-time advertisement exchange on behalf of the selected ad campaign.

The one or more KPIs may include estimations of total conversions/conversion rates or total clicks/click-through rates associated with the audience groups.

Selecting either the first ad campaign or the second ad campaign to submit a bid for the digital advertising space may further include implementing a set of pre-defined business rules designed to resolve audience conflicts.

Resolving the audience conflict may include determining a first probability of showing the ad from the first ad campaign and a second probability of showing the ad from the second ad campaign.

### BRIEF DESCRIPTION OF THE SEVERAL VIEWS OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a schematic diagram illustrating a demand-side platform (DSP) 100 for performing real-time bidding (RTB) in accordance with exemplary embodiments of the present invention;

FIG. 2 is a schematic diagram illustrating a system architecture for performing offline AD group optimization in accordance with exemplary embodiments of the present invention;

FIG. 3 is a flow chart illustrating an approach for online audience conflict resolution in accordance with exemplary embodiments of the present invention; and

FIG. 4 shows an example of a computer system capable of implementing the method and apparatus according to embodiments of the present disclosure.

### DETAILED DESCRIPTION

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention seek to provide various systems and methods for optimization of audience group (AG) definition in real-time bidding (RTB) as part of demand-side platforms (DSP) for digital advertising inventory in such a way that minimizes or eliminates audience conflict, while optimizing certain predefined KPIs (key performance indicators) at the same time. A discrete unit of digital advertising that is made available for sale may be referred to herein as a “placement opportunity” or an “ad placement opportunity” as what is being sold is an opportunity to place an advertisement, or perhaps some other content, within an electronic medium. Exemplary embodiments of the present invention may therefore provide various approaches for the automatic bidding for placement opportunities in digital advertising.

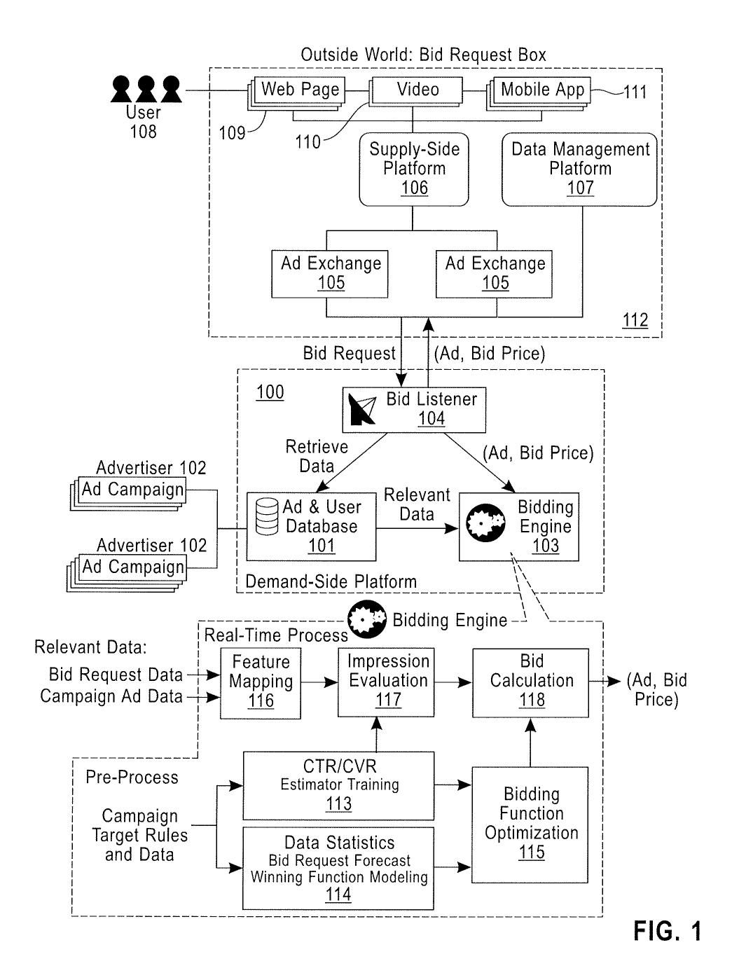

FIG. 1 is a schematic diagram illustrating a demand-side platform (DSP) 100 for performing real-time bidding (RTB) in accordance with exemplary embodiments of the present invention. The DSP 100 may include an Ad & User Database 101 which is responsible for receiving relevant Ad Campaign Information 102 from one or more advertisers. The Ad Campaign Information 102 may include an indication of what products and services are being promoted and what sorts of user attributes and characteristics define high value targets. The Ad & User Database 101 may take this information and pass relevant data to a Bidding Engine 103. The Bidding Engine 103 uses this information to determine whether to bid for displaying an ad from one or more of the Ad Campaigns 102 that it represents. If it is determined that a bid is to be made, the Bidding Engine 103 may also determine a value for this bid.

A Bid Listener 104 may be responsible for capturing the bid request from a Supply-side Platform 106, retrieving ad and user-related data from the Ad & User Database 101 and supplying them to the Bidding Engine 103. Such data may also be used to determine whether to issue a bid and what the value of such a bid may be. The Bid Listener 104 may also receive the bids from the Bidding Engine 103 and submit these bids to one or more Ad Exchanges 105. The Ad Exchanges 105 may receive multiple bids from multiple DSPs 100 and may select a winning bid. The Ad Exchanges 105 may receive digital ad inventory to sell from a Supply-Side Platform 106 and may also receive the user data therefrom. A Data Management Platform 107, which may collect, store and organize information pertaining to users, may be used here to identify users and correlate data about these users. The Data Management Platform 107 may receive its information from any number of various databases and information sources.

The Supply-Side Platform 106 may be able to communicate information about the Users 108, which may be accessing various Web Pages 109, Videos 110, Mobile Applications 111, etc., and may be able to display the winning ad to the users 108 in real-time. Together, the various Web Pages 109, Videos 110, Mobile Applications 111, etc., the Supply-Side Platform 106, the Data Management Platform 107, and the Ad Exchanges 105 may comprise a Bid Request group 112, as it is where the opportunity to display an advertisement to a particular user is generated.

The Bidding Engine 103 may issue bids based on a pre-processing component and a real-time processing component. In the pre-processing component, the Bidding Engine 103 may receive a set of ad campaign target rules and data, which may be used to create a correspondence between which sorts of ads should target which sorts of users and what value may be attributed to such ads. In the pre-processing component, a click-through rate (CTR)/conversion rate (CVR) estimator training unit 113 may train computer/machine learning algorithms to estimate a CTR and/or CVR for each ad campaign and for each type of potential user, such as, by AD. Campaign target rules and data may be used to perform this training. These campaign target rules and data may also be used by a Data Statistics unit 114, which may construct models for forecasting what bids may be necessary to win bid requests. A Bidding Function Optimization unit 115 may then make use of the trained estimators of the CTR/CVR estimator training unit 113 and the bid request forecasting models of the Data Statistics unit 114 to determine an optimum bid value to make and to pass this value to the real-time processing component.

In the real-time processing component, the Bidding Engine 103 may include a Feature Mapping unit 116 for receiving the relevant data including bid request data and campaign ad data and extracting particular features and mapping them to those that have been used for training the CTR/CVR estimators. An Impression Evaluation unit 117 may then use the mapped features from the Feature Matching unit 116, the CTR/CVR estimators from the CTR/CVR estimator training unit 113, and various statistical models from the Data Statistics unit 114 to determine an impression quality score. A high quality impression would warrant a subsequent bid offering. A Bid Calculation unit 118 may then pull together all of the generated information from the other units to determine an appropriate bid value.

As described above, exemplary embodiments of the present invention may resolve audience conflicts that would arise when a bidding engine representing multiple ad campaigns receives bids from more than one ad campaigns from the same advertiser for the same impression. It may be assumed here that only one digital ad may be selected from among the bidders and therefore all campaigns would be in competition with each other for the same impression. Thus exemplary embodiments of the present invention provide a means for resolving conflicts so that a bidding engine does not receive competing bids from multiple campaigns of the same advertiser.

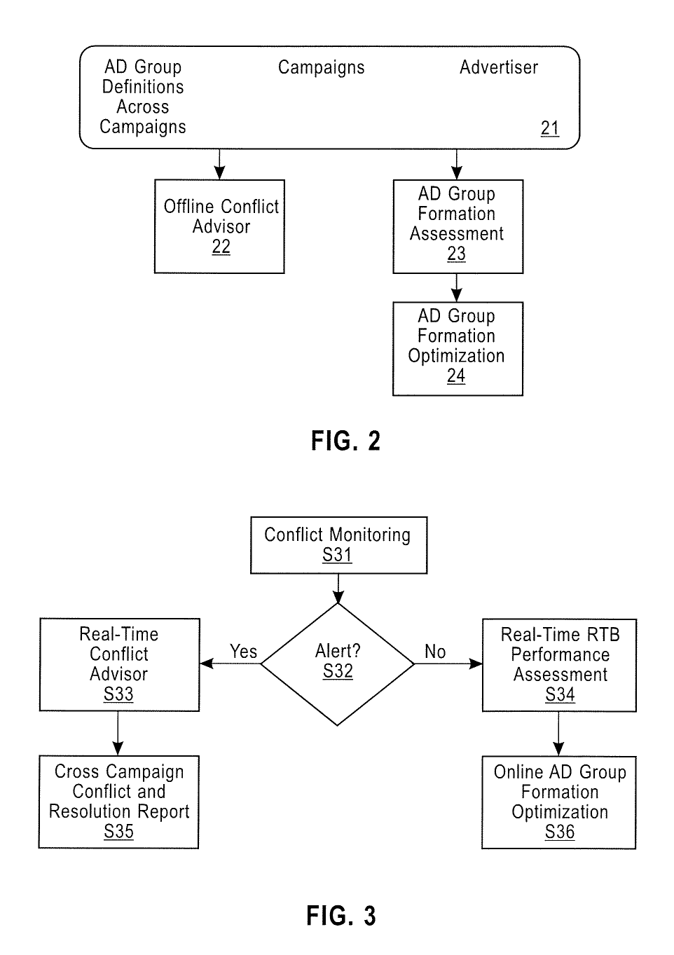

According to one such approach, the DSP 100 may favor the ad campaign having the highest budget so as to maximize the profit of the DSP 100. However, this solution may not be ideal from the perspective of the advertiser, who would rather put forth the bid that is most likely to maximize key performance indicators (KPI) which may include, for example, total conversions/conversion rates, total clicks/click-through rate, etc. Exemplary embodiments of the present invention may accomplish this objective by optimizing AD group formation across multiple ad campaigns of the same advertiser. This may be performed using a combined online and offline approach, where the offline approach provides a first level AD group formation and the online approach optimizes the AD groups in light of actual user data. FIG. 2 is a schematic diagram illustrating a system architecture for performing offline AD group optimization in accordance with exemplary embodiments of the present invention. A Demand-Side Platform (DSP) 21 may include a plurality of ad campaigns from one single advertiser and may further include definitions of AD groups across the multiple ad campaigns. These AD groups may be defined in terms of demographic categories of location, age, career, interests, intentions, etc. As described above, during the function of the DSP, an audience conflict may result when more than one ad campaign from the same advertiser would place a bid for the same user impression.

An Offline Conflict Advisor 22 may be used to detect potential conflicts, without reference to a particular user, based on ad campaign and audience definitions. The Offline Conflict Advisor 22 may also use a set of pre-defined business rules to resolve likely audience conflicts.

In general, a DSP may have pre-defined audience segments and a given user may be classified as qualifying for one or more of the pre-defined audience segments. An advertiser may define for itself AD groups in terms of the pre-defined audience segments. Thus, each AD group may be defined by which audience segments a user must have to be part of that AD group.

Some audience segments may be mutually exclusive. For example, a user cannot be in both an age bracket of between 20 and 39 years old and be in an age bracket of between 40 and 59 years old. However, other audience segments might not be mutually exclusive. For example, it is possible for a user to be both in the age bracket of between 20 and 39 years old while also being in a segment of small business owners.

The Offline Conflict Advisor 22 may therefore detect a potential conflict wherever it is possible for a theoretical user, having an arbitrary set of audience segments, to qualify for more than one AD group. Thus there would only be no potential conflict between two AD groups when any audience segment in a first AD group is mutually exclusive with any audience segment in a second group. This may be tested, for example, by establishing a set of theoretical users with every possible combination of audience segments and then seeing if a same user can qualify for more than one AD group. If such a theoretical user is found, then there is a potential conflict.

Accordingly, the Offline Conflict Advisor 22 may be used to make determinations as to what sorts of users may lead to an audience conflict and to predetermine how to resolve these audience conflicts. In this way, less processing may need to be performed in real-time.

An AD Group Formation Assessment unit 23 may be used to determine whether the initial set of AD groups that has been provided or generated is optimal for maximizing the given KPI, which may be, for example, total conversion rate. AD groups may be considered optimized when the AD groups are fine enough to differentiate between the ideal potential customers for each of the multiple ad campaigns. In the event that the AD groups are not optimal, an AD Group Formation Optimization unit 24 may optimize the AD groups to maximize KPI.

In optimizing the AD groups, the AD Group Formation Optimization unit 24 may construct a matrix representing the AD group definitions across the multiple campaigns. Each AD group may include one or more audience segments. An example of such a matrix is provided below in Table 1:

TABLE 1

| | AD Group 1 | AD Group 2 | | AD Group N |
|---|---|---|---|---|
| | (Budget B₁) | (Budget B₁) | . . . | (Budget B_{N}) |
| Audience | X | | | X |
| Segment 1 | | | | |
| Audience | X | X | | |
| Segment 2 | | | | |
| . . . | | | | |
| Audience | | X | | X |
| Segment M | | | | |

As can be seen from the above, the matrix establishes which Audience Segments 1, 2, . . . , M are included within which of the multiple AD groups 1, 2, . . . N. Each AD Group may have its own corresponding budget B. Each matrix cell may be associated with two parameters: cᵢ and bᵢ, where cᵢ indicates an estimated conversion rate of that audience segment for a given AD group and bᵢ indicates the estimated corresponding budget allocated to this group, both in the context of the particular AD group.

Both cᵢ and bᵢ may be estimated based on historical data. A given cell may be ignored where the corresponding AD group has never included a corresponding audience segment within the historical data.

The optimization goal may then be to maximize a total conversion rate cross all AD groups, while respecting the budget constraints for each AD group:

$$maximize {\sum }_{i = 1 , j = 1}^{M , N} {C}_{i}^{j} , \\ subject to {\sum }_{i = 1}^{M} {b}_{i}^{j} \leq {B}_{j} , j = 1 , … N$$

When the outcome of solving the optimization problem is different from the current AD group definitions, each sub-optimal AD group may be reformed.

Exemplary embodiments of the present invention may identify a plurality of different forms of audience conflicts and may assign a predetermined resolution for each form. An alert may also be generated for each form of audience conflict. For example, a first alert may indicate that there are two ad campaigns with substantially identical target audiences and the first ad campaign has a higher price target with the audience sizing being insufficient to accommodate both ad campaigns. This first alert may indicate that there is no chance for the second ad campaign to win a bid against the first ad campaign and so no bid will be issued for the second ad campaign.

A second alert may indicate that there are two ad campaigns with substantially identical target audiences and the first ad campaign has a higher price target with the audience sizing being large enough to accommodate both ad campaigns. Accordingly, a bid may be issued for the first and second ad campaigns.

A third alert may indicate that there are two ad campaigns with substantially identical target audiences and the first ad campaign has a lower price target with the audience sizing being large enough to accommodate both ad campaigns. Accordingly, a bid may be issued for the first and second ad campaigns.

A fourth alert may indicate that there are two ad campaigns with substantially identical target audiences and the first ad campaign has a lower price target with the audience sizing being insufficient to accommodate both ad campaigns. Accordingly, a bid may be issued for the second ad campaign and not the first ad campaign.

Exemplary embodiments of the present invention may accordingly resolve a potential audience conflict by determining when the conflict arises, characterizing the conflict according to one of the above categories, and moving forward with bids according to the conflict resolution.

However, exemplary embodiments of the present invention may alternatively allow an advertiser to establish a custom resolution for each form of conflict. Thus, business rules may be used to resolve conflicts. Examples of these business rules may include: assigning each ad campaign a business priority score and, in the event of a conflict, only presenting a bid for the ad campaign with the higher score; calculating an expected return on the advertisement on the given user for each ad campaign (e.g. a conversion rate) and then only placing a bid for the ad campaign with the higher expected business return; or assigning a campaign duration to each ad campaign and then selecting the ad campaign with the shortest remaining duration to bid with.

As described above, exemplary embodiments of the present invention may combine the above-described offline process with an online process so that audience conflict resolution may be more versatile and accurate. FIG. 3 is a flow chart illustrating an approach for online audience conflict resolution in accordance with exemplary embodiments of the present invention. First, the occurrence of audience conflict may be monitored, in real-time (Step S31). Campaigns and audiences may be continuously monitored, as they may change over time. As the campaigns and/or audiences change, advertisers may be alerted. As described above, audience conflict may occur when a bid request is received and more than one ad campaign from a single advertiser would otherwise issue a bid for an impression on a user. When a conflict is detected (Yes, S32) an alert may be generated. A real-time conflict advisor may apply certain optimization approach to resolve the conflict and determine which bid to place (Step S33). Pre-defined business rules can also be used to assist this decision process. A cross-campaign conflict and resolution report may be generated and provided to the advertiser (Step S34) so that the advertiser may be informed as to the nature of the audience conflict and the nature of the resolution. The cross-campaign conflict and resolution report may be embodied as a dashboard that graphically displays conflicts, and their resolutions, across the multiple ad campaigns of a given advertiser.

However, when no alert is generated (No, S32), for example, a user impression is bid upon by only one or none of the ad campaigns, a real-time bidding RTB performance assessment may be performed (Step S34). The RTB performance assessment may use the information concerning the actual user impression being offered and may assess how well actual users fall within the established set of AD groups. The AD groups may then be reformed in real-time to optimize for actual users (Step S36).

The real-time RTB performance assessment may measure and track, in real-time, one or more RTB performance indicators such as CTR, conversion rate, etc. The optimality of the AD groups may be reassessed, for example, when there is an appreciable drop in performance indicators. Alternatively, or additionally, AD groups may be optimized without regard to the RTB performance. This may occur, for example, in a manner similar to that described above in the offline approach.

However, the above steps S34 and S36 need not be performed exclusively upon the determination that no alert is to be generated in response to a bid request. Alternatively, these steps may be periodically performed in a manner that is independent of the performance of steps S33 and S35.

During the real-time audience conflict detection and resolution process, conflicts may be resolved by optimally determining which bid to place among the conflicting campaigns, for a given bid request. Specifically, such optimization may be achieved by maximizing the overall total conversions across the conflicting campaigns while respecting budget constraints.

Assuming that there are two ad campaigns, c₁ and c₂, whose AD groups have conflicts. This maximization problem may be cast as maximizing:

p₁×(N₁₂×w₁×v₁)+p₂×(N₁₂×w₂×v₂)

where p₁ is the probability of showing the ad from a first ad campaign c₁, p₂ is the probability of showing the ad from a second ad campaign c₂, N₁₂ is the estimated number of bidding requests targeting at users belonging to both group 1 and group 2, where group 1 is the set of users targeted by ad campaign cᵢ, group 2 is the set of users targeted by ad campaign c₂, and groups 1 and 2 are at least partially overlapping, indicating the audience conflict. Here w₁ is the winning function for ad group 1, w₂ is the winning function for ad group 2. Here, the winning function measures the probability of winning a bid request, v₁ is the conversion rate for ad group 1, and v₂ is the conversion rate for ad group 2. Here, a conversion rate measures the probability of converting a user once he or she sees the ad display. Examples of conversion are downloading a white paper, or filling out a registration form. Different campaign owners may have different definitions of a conversion.

It is also provided that the following constraints are satisfied:

p₁×(N₁₂×w₁×b₁)≦B₁

p₂×(N₁₂×w₂×b₂)≦B₂

p₁+p₂=1.0

where b₁ is the bidding price for ad group 1, b₂ is the bidding price for ad group 2, B₁ is the daily budget for ad group 1, and B₂ is the daily budget for ad group 2.

According to exemplary embodiments of the present invention, at the beginning of each day, the Conflict Advisor may determine values for p₁ and p₂ for the users in both groups 1 and 2. During the course of that day, for each ad request, it may be decided which ad is shown using one of three possible approaches: (1) weight-based ad determination, (2) probabilistic ad determination in which it is determined which ad to show using a value that is randomly generated in accordance with the probabilities p₁ and p₂, (3) conversion-guided ad determination.

Here, the conflict advisor may also be used to determine the p₁ and p₂ for predetermined time buckets throughout the day to adapt to daily dynamics as conversion rates, winning rate, etc. vary with the time of day.

While the above optimization example only uses two ad campaigns, this approach may be applied to resolve audience conflicts among multiple campaigns.

In greater detail, the weight-based approach for ad determination may assign a weight to c₁ and c₂ in proportion to p₁ and p₂. During RTB, for each ad request, an ad may be picked from either c₁ or c₂ based on their weights. The higher the weight, the more likely that ad campaign may be picked. The weights of c₁ and c₂ may then be adjusted in real-time such that the closer the displaying frequency of cᵢ is to pᵢ, the lower the weight becomes.

In the conversion-guided ad determination, during RTB, for each ad request, the conversion probability cvr(c₁) for showing c₁ ad to the user, and cvr(c₂) for showing c₂ ad to the user, may be estimated for that specific time bucket. The ad that has the higher conversion probability may be picked and shown to the user (or at least the appropriate bid may be generated). The displaying frequency for each ad may be monitored and the bid selection may be made to keep the actual ads displayed in accordance with p₁ and p₂.

In performing online AD group formation optimization, exemplary embodiments of the present invention may utilize a multi-arm bandit (MAB) approach in which a balance is struck between attempting to find new knowledge (exploration) and optimizing decisions based on existing knowledge (exploitation). In general, MAB seeks to maximize the sum of rewards earned through a sequence of lever (K) pulls.

The MAB approach may be applied to exemplary embodiments of the present invention by defining K as the total number of audience segments×the total number of AD groups across all campaigns. Each “turn on the lever” is defined as including a particular audience segment into a specific AD group. The reward is defined as the conversion rate of each audience segment for a given AD group. Here, the previous AD group definition serves as the existing knowledge while the goal of the approach is to maximize the total number of rewards (conversion rates) by experimenting with the inclusion or exclusion of audience groups within each AD group.

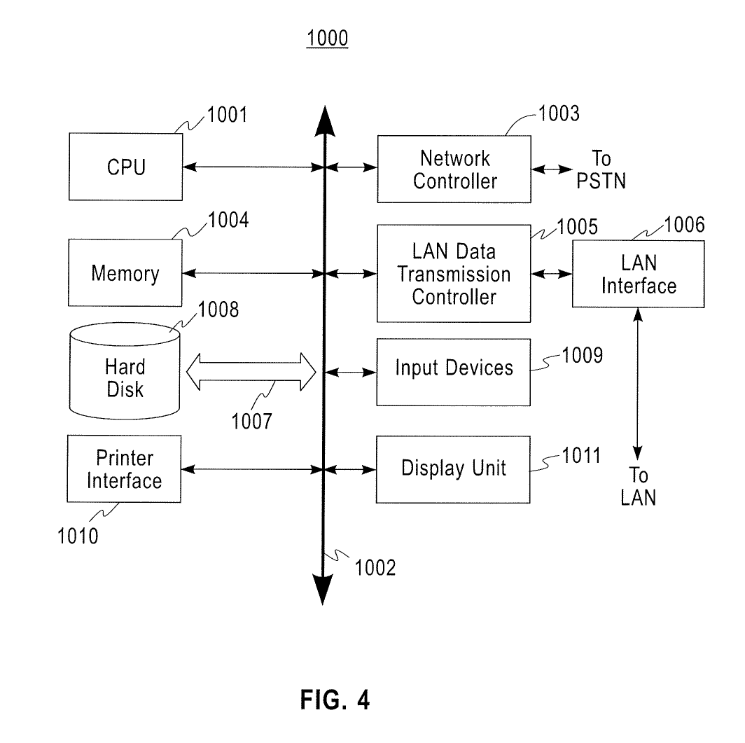

FIG. 4 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for automatic placement opportunity bidding of digital advertising in a real-time advertisement exchange, comprising:
receiving one or more requests for an ad placement opportunity from the real-time advertisement exchange or directly from a content publisher, the one or more requests including information pertaining to a user who is presently viewing on-line content;
identifying one or more audience segments that the user belongs to based on the received information pertaining to the user;
identifying an audience group that the user belongs to based on the identified one or more audience segments;
determining if a first ad campaign of an advertiser should respond to the one or more requests based on the identified audience group of the user;
determining if a second ad campaign of the advertiser should respond to the one or more requests based on the identified audience group of the user;
resolving an audience conflict and identify one single ad campaign, of the first and second ad campaigns, that should submit a bid for the placement opportunity when it is determined that both the first ad campaign and the second as campaign should respond to the one or more requests; and
submitting the bid for the placement opportunity to the real-time advertisement exchange on behalf of the identified one single ad campaign, of the first and second ad campaigns that should submit the bid.

2. The method of claim 1, wherein the audience group that the user belongs to is identified based on the identified one or more audience segments using a pre-arranged table defining audience groups by pluralities of audience segments.

3. The method of claim 2, wherein the pre-arranged table defining audience groups is optimized by maximizing one or more key performance indicators (KPI) while respecting budget constraint for each audience group.

4. The method of claim 3, wherein the one or more KPIs include estimations of total conversions/conversion rates or total clicks/click-through rates associated with the audience groups.

5. The method of claim 1, wherein one or more factors are considered to resolve an audience conflict resulting from the determination that both the first ad campaign and the second ad campaign should submit a bid for the placement opportunity request.

6. The method of claim 5, wherein the one or more factors include maximizing one or more key performance indicators (KPI) while respecting budget constraints for the first and second ad campaigns.

7. The method of claim 6, wherein the one or more KPIs include estimations of total conversions/conversion rates or total clicks/click-through rates associated with the definitions of the audience groups.

8. The method of claim 5, wherein the one or more factors include a set of pre-defined business rules designed to resolve audience conflicts.

9. The method of claim 5, wherein resolving the audience conflict includes determining a first probability of showing the ad from the first ad campaign and a second probability of showing the ad from the second ad campaign.

10. The method of claim 9, wherein the first and second probabilities respectively control the frequency of determining the campaign should respond to the one or more requests in favor of the first and second ad campaign, wherein the first and second probabilities sum up to 1.

11. A method for automatic placement opportunity bidding for digital advertising in a real-time advertisement exchange, comprising:
defining a first audience group as a target audience for a first ad campaign, the first audience group including a first plurality of audience segments;
defining a second audience group as a target audience for a second ad campaign, the second audience group including a second plurality of audience segments;
optimizing the definition of audience groups across both the first and second ad campaigns;
receiving a placement opportunity request from the real-time advertisement exchange, or directly from a content publisher, the placement opportunity request including information pertaining to a user who is presently viewing on-line content;
determining if the first ad campaign should respond to the placement opportunity request based on the definition of the first audience group and the information pertaining to the user who is presently viewing on-line content;
determining if the second ad campaign should respond to the placement opportunity request based on the definition of the second audience group and the information pertaining to the user who is presently viewing on-line content;
selecting either the first ad campaign or the second ad campaign to submit a bid for the placement opportunity by resolving potential audience conflict based on a maximization of one or more key performance indicators (KPI) while respecting budget constraints for each of the first and second ad campaigns; and
submitting a bid for the placement opportunity to the real-time advertisement exchange on behalf of the selected ad campaign.

12. The method of claim 11, wherein the one or more KPIs include estimations of total conversions/conversion rates or total clicks/click-through rates associated with the audience groups.

13. The method of claim 11, wherein selecting either the first ad campaign or the second ad campaign to submit a bid for the digital advertising space further includes implementing a set of pre-defined business rules designed to resolve audience conflicts.

14. The method of claim 11, wherein resolving the audience conflict includes determining a first probability of showing the ad from the first ad campaign and a second probability of showing the ad from the second ad campaign.

15. A computer system comprising:
a processor; and
a non-transitory, tangible, program storage medium, readable by the computer system, embodying a program of instructions executable by the processor to perform method steps for automatic placement opportunity bidding for digital advertising in a real-time advertisement exchange, the method comprising:
defining a first audience group as a target audience for a first ad campaign, the first audience group including a first plurality of audience segments;
defining a second audience group as a target audience for a second ad campaign, the second audience group including a second plurality of audience segments;
optimizing the definition of audience groups across both the first and second ad campaigns;
receiving a placement opportunity request from the real-time advertisement exchange, or directly from a content publisher, the placement opportunity request including information pertaining to a user who is presently viewing on-line content;
determining if the first ad campaign should respond to the placement opportunity request based on the definition of the first audience group and the information pertaining to the user who is presently viewing on-line content;
determining if the second ad campaign should respond to the placement opportunity request based on the definition of the second audience group and the information pertaining to the user who is presently viewing on-line content;
selecting either the first ad campaign or the second ad campaign to submit a bid for the placement opportunity by resolving potential audience conflict based on a maximization of one or more key performance indicators (KPI) while respecting budget constraints for each of the first and second ad campaigns; and
submitting a bid for the placement opportunity to the real-time advertisement exchange on behalf of the selected ad campaign.

16. The computer system of claim 15, wherein the one or more KPIs include estimations of total conversions/conversion rates or total clicks/click-through rates associated with the audience groups.

17. The computer system of claim 15, wherein selecting either the first ad campaign or the second ad campaign to submit a bid for the digital advertising space further includes implementing a set of pre-defined business rules designed to resolve audience conflicts.

18. The computer system of claim 15, wherein resolving the audience conflict includes determining a first probability of showing the ad from the first ad campaign and a second probability of showing the ad from the second ad campaign.
